(19) United States
(12) Patent Application Publication
(10) Pub. No.: US 2024/0177489 A1
(43) Pub. Date: May 30, 2024

(54) FRICTIONLESS PARKING MANAGEMENT SYSTEM

(71) Applicant: IPC Technology Group, LLC, Milwaukee, WI (US)

(72) Inventors: Darrin Murray, Round Lake, IL (US); Anthony Janowiec, Lac Du Flambeau, WI (US)

(21) Appl. No.: 18/513,795

(22) Filed: Nov. 20, 2023

Related U.S. Application Data
(60) Provisional application No. 63/385,314, filed on Nov. 29, 2022.

(51) Int. Cl. G06V 20/52; G06K 7/14; G06V 10/75; G06V 20/62

(52) U.S. Cl. CPC G06V 20/52; G06K 7/1417; G06V 10/75; G06V 20/625; G06Q 2240/00

(57) ABSTRACT

A method includes receiving a first vehicle identifier identifying a vehicle entering a parking facility derived from image data captured at an entrance of the parking facility. The method includes receiving a parking request requesting parking access for the vehicle. The parking request includes a second vehicle identifier identifying the vehicle and one or more parking parameters. The method includes determining that the vehicle identified by the first vehicle identifier matches the vehicle identified by the second vehicle identifier. The method includes, in response, generating a parking session for the vehicle based on the one or more parking parameters. The method includes receiving a third vehicle identifier identifying the vehicle exiting the parking facility. The method includes determining that the vehicle identified by the third vehicle identifier matches the vehicle identified by the first and second vehicle identifiers. The method includes, in response, completing the parking session.

### CROSS REFERENCE TO RELATED APPLICATION

The present application claims the filing benefits of U.S. provisional application Ser. No. 63/385,314, filed Nov. 29, 2022, which is hereby incorporated herein by reference in its entirety.

### TECHNICAL FIELD

This disclosure relates to frictionless parking management systems.

### BACKGROUND

Conventional parking management systems control parking sessions by providing a user a parking ticket. The user generally receives the parking ticket upon entry to the parking facility, via, for example, a ticket kiosk at a gate barring entry to the parking facility. The user then presents the parking ticket along with payment when exiting the parking lot.

### SUMMARY

One aspect of the disclosure provides a method for a frictionless parking management system. The computer-implemented method is executed by data processing hardware that causes the data processing hardware to perform operations. The operations include receiving a first vehicle identifier identifying a vehicle entering a parking facility. The first vehicle identifier is derived from image data captured via a first image sensor mounted at an entrance of the parking facility. The operations include receiving, from a user device, a parking request requesting parking access for the vehicle at the parking facility. The parking request includes a second vehicle identifier identifying the vehicle and one or more parking parameters. The operations include determining that the first vehicle identifier matches the second vehicle identifier. In response to determining that the first vehicle identifier and the second vehicle identifier match, the operations include generating a parking session for the vehicle based on the one or more parking parameters. The operations include receiving a third vehicle identifier identifying the vehicle exiting the parking facility. The third vehicle identifier is derived from image data captured via a second image sensor mounted at an exit of the parking facility. The operations include determining that the third vehicle identifier matches the first vehicle identifier and the second vehicle identifier. The operations include, in response to determining that the third vehicle identifier matches the first vehicle identifier and the second vehicle identifier, completing the parking session.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for a frictionless parking management system.

FIG. 2 is a schematic view of exemplary components of the frictionless parking management system of FIG. 1.

FIG. 3 a flowchart of an example arrangement of operations for a method for a frictionless parking management system.

FIG. 4 is a schematic view of an example computing device that may be used to implement the systems and methods described herein.

Like reference symbols in the various drawings indicate like elements.

### DETAILED DESCRIPTION

Conventional parking management systems control parking sessions of a parking facility by restricting access to the parking facility. For example, the parking facility includes a gate or other obstacle prohibiting or discouraging access to the parking facility unless a user is authorized to enter. For example, a user may be authorized by possessing a parking pass or by accepting a parking ticket. Thus, it is common for a user for a parking facility to stop at an entrance gate, receive a parking ticket, and pay the parking ticket via an attendant or kiosk. This inconveniences the user and restricts traffic flow to and from the parking facility.

Implementations herein include a parking management system that includes a parking manager that facilitates frictionless parking for users. Users may drive directly into a parking facility or lot, navigate to an open parking location, and park without any delays. The system implements one or more image sensors to capture vehicle identifiers as vehicles enter and exit the parking facility. Users, once parked, confirm the vehicle identifiers to generate parking sessions. The parking manager can automatically process and complete parking sessions when the user exits the parking facility. Thus, the parking management system enables users to park without requiring the impediments of a gate, a ticket kiosk, and/or a parking attendant.

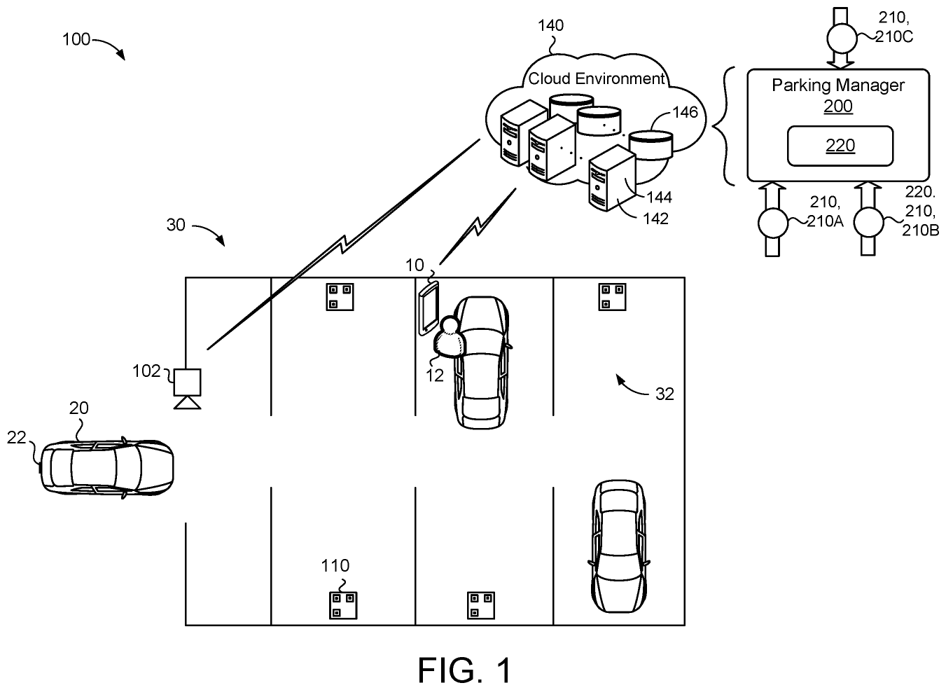

Referring to FIG. 1, in some implementations, an example parking management system 100 includes a remote system 140 in communication with one or more user devices 10. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The user device 10 may correspond to any computing device, such as a laptop, a mobile device (i.e., a smart phone), a smart watch, a tablet, etc.

In some examples, the remote system 140 executes a parking manager 200. The parking manager 200 receives a first vehicle identifier 210, 210A identifying a vehicle entering a parking facility 30. In some implementations, the first vehicle identifier 210A is derived from image data captured by an image sensor 102 (e.g., a camera). The image sensor 102 may be mounted at or near an entrance of the parking facility 30 such that the image sensor 102 has a field of view that includes at least a portion of the entrance of the parking facility 30. Vehicles 20 that enter the parking facility 30 pass through the field of view of the image sensor 102 and the image sensor 102 captures image data representative of the vehicle. The image sensor 102, the parking manager 200, and/or a third party server extracts, from the image data, the first vehicle identifier 102A (e.g., via machine vision or a license plate recognition system). For example, the first vehicle identifier 102A includes a license plate number/value 22 that uniquely identifies the vehicle. Other vehicle identifiers may include vehicle make, color, design, etc.

The parking facility 30 does not require the vehicle 20 to stop at a gate, kiosk, or any other impediment prior to entering or navigating the parking facility 30. After the vehicle 20 enters the parking facility 30, the vehicle 20 maneuvers to an available parking space 32 and parks. After parking, in some examples (e.g., when a user 12 of the vehicle 20 is a transient parker and not a permit parker or subscription parker), the user 12 of the vehicle 20 transmits, to the parking manager 200, via a user device 10, a parking request 220 requesting parking access for the vehicle 20 at the parking facility 30. The parking request 220 includes a second vehicle identifier 210, 210B identifying the vehicle 20. For example, the user 12 provides the license plate number 22 to the parking manager 200.

Optionally, the user 12 generates/transmits the parking request 220 via an application executing on the user device 10. For example, the user device 10 executes a standalone parking application or a web browser that allows the user 12 to enter (e.g., via a keyboard, voice, etc.) the second vehicle identifier 210B. In some examples, the user 12 scans a quick response (QR) code 110 with the user device 10. The QR code 110 directs the user device 10 to execute the proper application. For example, scanning the QR code 110 prompts the user device 10 to execute a standalone application or directs a web browser to a specific URL. The QR code 110 may include one or more parameters that are provided to the parking manager 200 via the parking request 220. For example, the QR code 110 includes a location of the parking facility 30 and/or a specific parking location 32 within the parking facility 30. The QR code 110 may be specific to the parking location 32 that the vehicle 20 parks in (e.g., displayed at or within the parking location 32. Alternatively, the QR code 110 is generic to the parking facility 30 and displayed at various locations (e.g., at signage) around the parking facility 30.

The image sensor 102 and/or the user device 10 may communicate with the parking manager 200 in any number of ways. For example, the communications may include wireless or wired communications directly to the parking manager 200 (e.g., when the remote system 140 is located on-premises at or near the parking facility 30) or via one or more intermediaries (e.g., servers). The image sensor 102 may communicate with the parking manager 200 via an application programming interface (API) conforming to representational state transfer (REST) constraints. In some examples, the remote system executes in “the cloud” and the image sensor 102 and/or the user device 10 communicate with the parking manager 200 via the Internet. The user device 10 may communicate with the parking manager 200 via cellular communication technologies or via any other wireless communication protocols (e.g., WIFI or BLUETOOTH).

The parking manager 200, after receiving both the first vehicle identifier 210A and the second vehicle identifier 210B, determines that the first vehicle identifier 210A matches or is the same as the second vehicle identifier 210B. That is, the parking manager 200 matches the first vehicle identifier 210A to the second vehicle identifier 210B (e.g., based on a similarity between the first vehicle identifier 210A and the second vehicle identifier 210B). Alternatively, the parking manager 200 determines whether the vehicle 20 associated with the first vehicle identifier 210A matches the vehicle 20 associated with the second vehicle identifier 210B (i.e., the vehicle identifiers 210 need not match in some scenarios). In response, the parking manager 200 generates a parking session 250 for the vehicle 20. The parking session 250 is uniquely associated with the vehicle 20 which is uniquely associated with the first vehicle identifier 210A and the second vehicle identifier 210B.

The parking manager 200, after generating the parking session 250, receives a third vehicle identifier 210, 210C identifying the vehicle 20 as the vehicle 20 exits the parking facility 30. In some examples, the third vehicle identifier 210C is derived from image data captured by a second image sensor 102 with a field of view of an exit of the parking facility 30. For example, the third vehicle identifier 210C includes the license plate number 22 of the vehicle 20. In some examples, the first image sensor 102 is the same as the second image sensor 102 (e.g., when the entrance and the exit of the parking facility 30 are co-located) while in other examples the first image sensor 102 and the second image sensor 102 are separate devices. The parking manager 200, in response to receiving the third vehicle identifier 210C, processes and completes the parking session 250.

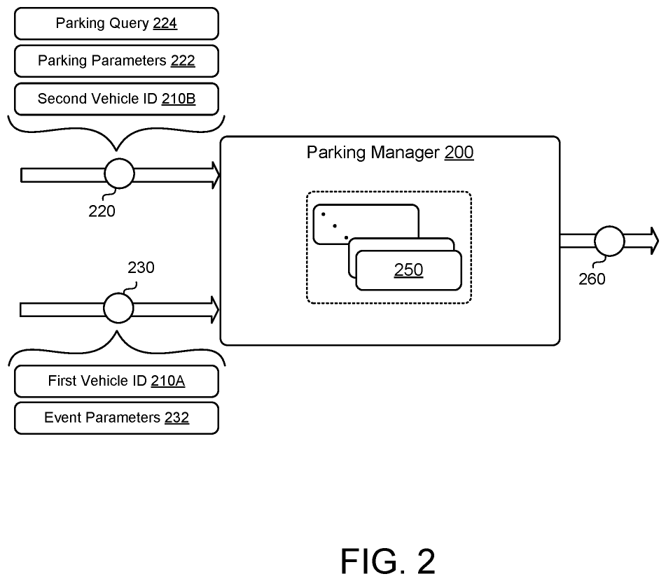

Referring now to FIG. 2, in some implementations, the parking manager 200 receives the first vehicle identifier 210A within a vehicle event message 230. The vehicle event message includes information derived from image data captured by the image sensor 102 (e.g., the first vehicle identifier 210A) and other event parameters 232 such as a location of the image sensor 102 and/or the vehicle 20, a timestamp of when the vehicle 20 entered the parking facility 30 or when the image data was captured, other identifying characteristics of the vehicle 20, a location of the parking facility 30, etc. The event parameters 232 may be associated with the corresponding parking session 250 that is generated after receiving the parking request 220.

The parking request 220 includes the second vehicle identifier 210B and, optionally, one or more parking parameters 222. The parking parameters 222 may include details such as a parking rate, a specific parking product, a parking duration, a promotional code, user details (e.g., name, contact information, user credentials, payment information, etc.), and the like. The parking manager 200 may generate the parking session 250 based in part on the parking parameters 222. The parking parameters may at least in part be supplied by the user 12 via the same interface the user 12 provides the second vehicle identifier 210B (e.g., a form or other user-selectable interface provided by a graphical user interface (GUI) executing on the user device 10).

The parking manager 200 generates and maintains a parking session 250 for each independent vehicle 20 located within the parking facility 30. Upon receipt of the third vehicle identifier 210C indicating that a corresponding vehicle 20 has exited the parking facility 30, the parking manager 200 completes the parking session 250. For example, the parking facility 30 completes payment for the parking session 250 based on the parking parameters 222, the event parameters 232, and any other relevant information. For example, the parking manager 200 receives the third vehicle identifier 210C via an event message 230 that includes a timestamp indicating when the vehicle 20 exited the parking facility 30. Based on the timestamp of the first event message 230 when the vehicle 20 entered the parking facility 30 and the timestamp of the second event message 230 when the vehicle 20 exited the parking facility 30, the parking manager 200 may determine a parking duration and charge for the parking session 250 accordingly.

In some implementations, the parking request 220 includes a parking query 224. The parking query 224 includes a portion of the first vehicle identifier 210A. For example, the user 12 may begin entering or providing the second vehicle identifier 210B (e.g., begins reciting the license plate number 22 of the vehicle 20). The parking manager 200, in response, may perform a wildcard smart search and return to the user 12 the first vehicle identifier 210A. For example, the parking manager 200 returns all vehicle identifiers 210 that represent vehicles 20 currently located within the parking facility 30 and include an associated vehicle identifier 210 portion that matches the portion provided by the user 12. The user 12 may then select from the provided vehicle identifiers 210 the vehicle identifier 210 that matches the second vehicle identifier 210B of the user's vehicle 20. For example, the parking manager 200, via the user device 10, displays multiple vehicle identifiers 210 that potentially match the vehicle identifier 210 of the user's vehicle 20, and the user 12 selects the appropriate vehicle identifier 210.

In some examples, the parking request 220 includes location information representative of a location of the user device 10 and/or the vehicle 20. In response, the parking manager 200 transmits, to the user device 10, parking facility identification information identifying the parking facility 30 based on the location information. For example, the user device 10, using a GPS sensor of the user device 10, transmits the approximate location of the user device 10 to the parking manager 200. The parking manager 200, based on the location of the user device 10, determines which parking facility 30 the vehicle 20 is located within. The parking manager 200 provides the parking facility identification information to the user 12 to facilitate generation of the parking request 220 and/or the parking session 250.

Optionally, the parking manager 200 generates one or more notifications 260 for the user device 10. For example, upon generation and/or completion of a corresponding parking session 250, the parking manager 200 provides a notification 260 to the user device 10 (e.g., based on contact information provided via the parking request 220). The notification 260 may include any relevant information, such as parking facility 30 information, vehicle location, estimated parking costs, actual parking costs, security alerts, etc.

In some implementations, the user 12 reserves a parking location 32 by transmitting the parking request 220 prior to entering the parking facility 30. In this scenario, the parking manager 200 matches the second vehicle identifier 210B from the parking request to the first vehicle identifier 210A after the vehicle 20 enters the parking facility 30 to generate the appropriate parking session 250.

Thus, the parking manager 200 provides gateless or frictionless parking management for user 12 using a parking facility 30 for parking facilities with or without gates, attendants, kiosks, etc. The parking manager 200 identifies vehicles 20 entering and exiting the parking facility 30 (e.g., at a gate or gateless entrance) via an image sensor capturing image data representative of a first vehicle identifier 210A of the vehicle 20. For transient users 12 (i.e., users that do not have a subscription to the parking facility, such as a monthly parking pass) may generate a parking session by sending the parking manager 250 a second vehicle identifier 210B that matches the first vehicle identifier 210A. Subscription-based users may generate a parking session 250 automatically by entering the parking facility 30 without the need to provide the second vehicle identifier 210B as the parking manager 250 may store vehicle identifiers 210 of all authorized users 12. The parking manager 250 may automatically complete a parking session 250 when receiving a third vehicle identifier 210C indicating that the vehicle 20 has exited the parking facility 30.

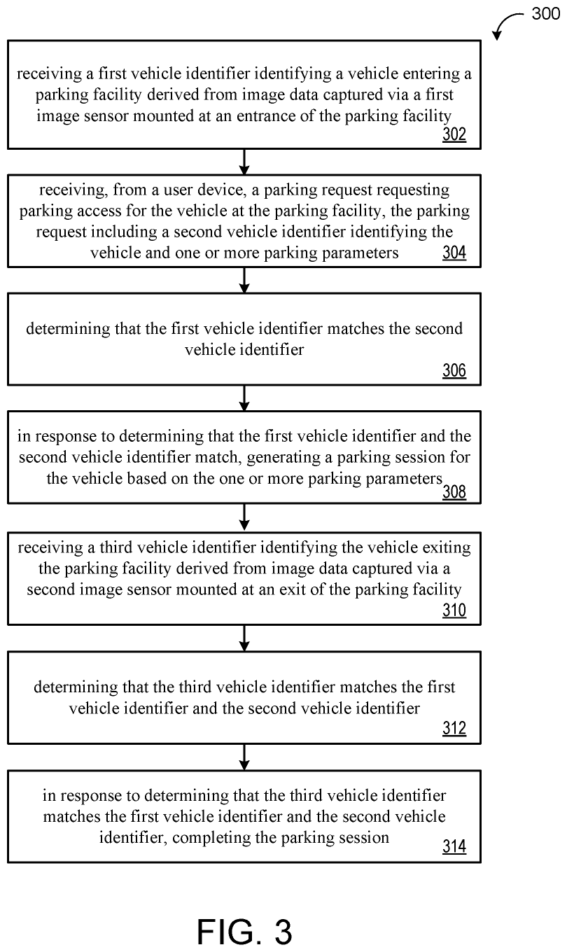

FIG. 3 is a flowchart of an exemplary arrangement of operations for a method 300 for a gateless or frictionless parking management system. The method 300 includes, at operation 302, receiving a first vehicle identifier 210A identifying a vehicle 20 entering a parking facility 30. The first vehicle identifier 210A is derived from image data captured via a first image sensor 102 (e.g., a camera or the like) mounted at an entrance of the parking facility 30. At operation 304, the method 300 includes receiving, from a user device 10, a parking request 220 requesting parking access for the vehicle 20 at the parking facility 30. The parking request 220 includes a second vehicle identifier 210B identifying the vehicle 20 and one or more parking parameters 222. The method 300, at operation 306, includes determining that the first vehicle identifier 210A matches the second vehicle identifier 210B. At operation 308, the method 300 includes, in response to determining that the first vehicle identifier 210A and the second vehicle identifier 210B match, generating a parking session 250 for the vehicle 20 based on the one or more parking parameters 222. The method 300, at operation 310, includes receiving a third vehicle identifier 210C identifying the vehicle 20 exiting the parking facility 30. The third vehicle identifier 210C is derived from image data captured via a second image sensor 102 mounted at an exit of the parking facility 30. At operation 312, the method 300 includes determining that the third vehicle identifier 210C matches the first vehicle identifier 210A and the second vehicle identifier 210B. In response to determining that the third vehicle identifier 210C matches the first vehicle identifier 210A and the second vehicle identifier 210B, the method 300, at operation 314, includes completing the parking session 250.

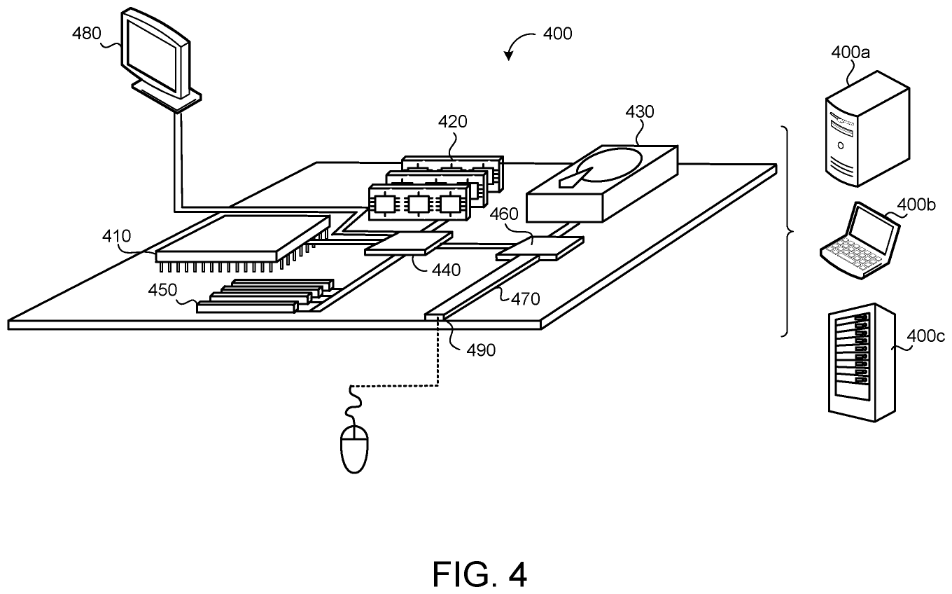

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A computer-implemented method executed by data processing hardware that causes the data processing hardware to perform operations comprising:
receiving a first vehicle identifier identifying a vehicle entering a parking facility, the first vehicle identifier derived from image data captured via a first image sensor mounted at an entrance of the parking facility;
receiving, from a user device, a parking request requesting parking access for the vehicle at the parking facility, the parking request comprising:
a second vehicle identifier identifying the vehicle; and
one or more parking parameters;
determining that the vehicle identified by the first vehicle identifier matches the vehicle identified by the second vehicle identifier;
in response to determining that the vehicle identified by the first vehicle identifier and the vehicle identified by the second vehicle identifier match, generating a parking session for the vehicle based on the one or more parking parameters;
receiving a third vehicle identifier identifying the vehicle exiting the parking facility, the third vehicle identifier derived from image data captured via a second image sensor mounted at an exit of the parking facility;
determining that the vehicle identified by the third vehicle identifier matches the vehicle identified by the first vehicle identifier and the vehicle identified by the second vehicle identifier; and
in response to determining that the vehicle identified by the third vehicle identifier matches the vehicle identified by the first vehicle identifier and the vehicle identified by the second vehicle identifier, completing the parking session.

2. The method of claim 1, wherein:
the first image sensor comprises a first camera; and
the second image sensor comprises a second camera.

3. The method of claim 1, wherein the first vehicle identifier, the second vehicle identifier, and the third vehicle identifier each comprise a license plate number.

4. The method of claim 1, wherein receiving the parking request from the user device is in response to the user device scanning a quick response (QR) code disposed at the parking facility.

5. The method of claim 1, wherein receiving the parking request from the user device comprises:
receiving, from the user device, a parking query, the parking query comprising a portion of the first vehicle identifier; and
transmitting, to the user device, the first vehicle identifier.

6. The method of claim 5, wherein transmitting, to the user device, the first vehicle identifier comprises transmitting, to the user device, a plurality of vehicle identifiers, each vehicle identifier of the plurality of vehicle identifiers comprising the portion of the first vehicle identifier.

7. The method of claim 1, wherein the one or more parking parameters comprise at least one of:
a parking rate;
a parking duration; or
payment information.

8. The method of claim 1, wherein the user device comprises a mobile phone.

9. The method of claim 1, wherein receiving the parking request from the user device comprises:
receiving, from the user device, location information representative of a location of the user device; and
transmitting, to the user device, parking facility identification information identifying the parking facility based on the location information.

10. The method of claim 9, wherein the location information is derived from a global positioning system (GPS) sensor of the user device.

11. A system comprising:
data processing hardware; and
memory hardware in communication with the data processing hardware, the memory hardware storing instructions that when executed on the data processing hardware cause the data processing hardware to perform operations comprising:
receiving a first vehicle identifier identifying a vehicle entering a parking facility, the first vehicle identifier derived from image data captured via a first image sensor mounted at an entrance of the parking facility;
receiving, from a user device, a parking request requesting parking access for the vehicle at the parking facility, the parking request comprising:
a second vehicle identifier identifying the vehicle; and
one or more parking parameters;
determining that the vehicle identified by the first vehicle identifier matches the vehicle identified by the second vehicle identifier;
in response to determining that the vehicle identified by the first vehicle identifier and the vehicle identified by the second vehicle identifier match, generating a parking session for the vehicle based on the one or more parking parameters;
receiving a third vehicle identifier identifying the vehicle exiting the parking facility, the third vehicle identifier derived from image data captured via a second image sensor mounted at an exit of the parking facility;
determining that the vehicle identified by the third vehicle identifier matches the vehicle identified by the first vehicle identifier and the vehicle identified by the second vehicle identifier; and
in response to determining that the vehicle identified by the third vehicle identifier matches the vehicle identified by the first vehicle identifier and the vehicle identified by the second vehicle identifier, completing the parking session.

12. The system of claim 11, wherein:
the first image sensor comprises a first camera; and
the second image sensor comprises a second camera.

13. The system of claim 11, wherein the first vehicle identifier, the second vehicle identifier, and the third vehicle identifier each comprise a license plate number.

14. The system of claim 11, wherein receiving the parking request from the user device is in response to the user device scanning a quick response (QR) code disposed at the parking facility.

15. The system of claim 11, wherein receiving the parking request from the user device comprises:
receiving, from the user device, a parking query, the parking query comprising a portion of the first vehicle identifier; and
transmitting, to the user device, the first vehicle identifier.

16. The system of claim 15, wherein transmitting, to the user device, the first vehicle identifier comprises transmitting, to the user device, a plurality of vehicle identifiers, each vehicle identifier of the plurality of vehicle identifiers comprising the portion of the first vehicle identifier.

17. The system of claim 11, wherein the one or more parking parameters comprise at least one of:
a parking rate;
a parking duration; or
payment information.

18. The system of claim 11, wherein the user device comprises a mobile phone.

19. The system of claim 11, wherein receiving the parking request from the user device comprises:
receiving, from the user device, location information representative of a location of the user device; and
transmitting, to the user device, parking facility identification information identifying the parking facility based on the location information.

20. The system of claim 19, wherein the location information is derived from a global positioning system (GPS) sensor of the user device.
